(19) United States
(12) Patent Application Publication
(10) Pub. No.: US 2026/0088732 A1
(43) Pub. Date: Mar. 26, 2026

(54) POWER CONVERTER

(71) Applicant: TOYOTA JIDOSHA KABUSHIKI KAISHA, Toyota-shi (JP)

(72) Inventors: Kazuma FUJIWARA, Kobe-shi (JP); Hiroshi Morita, Susono-shi (JP)

(73) Assignee: TOYOTA JIDOSHA KABUSHIKI KAISHA, Toyota-shi (JP)

(21) Appl. No.: 19/209,072

(22) Filed: May 15, 2025

(30) Foreign Application Priority Data
Sep. 20, 2024 (JP) 2024-164005

(51) Int. Cl. H02M 7/537

(52) U.S. Cl. CPC H02M 7/537

(57) ABSTRACT

A power converter includes a first inverter connected to a power line and each phase of the open-end winding motor. The power line is connected to an energy storage device. The power converter further includes: a second inverter connected to the power line and each phase of the open-end winding motor; and a line-connecting switching device provided on a cathode line of the power line at a position between the first inverter and the second inverter. The line-connecting switching device is a semiconductor switching device having larger parasitic capacitance than a switching device of the first inverter and a switching device of the second inverter.

### CROSS-REFERENCE TO RELATED APPLICATION

This application claims priority to Japanese Patent Application No. 2024-164005 filed on Sep. 20, 2024. The disclosure of the above-identified application, including the specification, drawings, and claims, is incorporated by reference herein in its entirety.

### BACKGROUND

### 1. Technical Field

The present disclosure relates to power converters, and more particularly to a power converter including two inverters that drive an open-end winding motor.

### 2. Description of Related Art

A power converter including a first inverter, a second inverter, and a switch has been proposed as this type of power converter (see, for example, Japanese Unexamined Patent Application Publication No. 2022-177342 (JP 2022-177342 A)). In this power converter, the first inverter is connected to power lines connected to a battery, and is also connected to each phase of an open-end winding motor. The second inverter is connected to the power lines, and is also connected to each phase of the open-end winding motor. The switch of this power converter is provided on a cathode line of the power lines at a position between the first inverter and the second inverter. This power converter switches the drive mode between a Y-connection drive mode in which the switch is off and a Δ-connection drive mode in which the switch is on.

### SUMMARY

In the above power converter, however, a switching surge may occur due to wire inductance and a breaking current when the switch is turned from on to off. A high surge voltage may damage a device of the switch.

A power converter of the present disclosure can reduce a surge voltage of a switching surge that occurs when a switch is turned from on to off.

The power converter of the present disclosure adopts the following measures.

The power converter of the present disclosure is a power converter connected to an energy storage device and a three-phase open-end winding motor.

The power converter includes a first inverter connected to a power line and each of three phases of the open-end winding motor. The power line is connected to the energy storage device. The power converter further includes:
a second inverter connected to the power line and each of the three phases of the open-end winding motor; and
a line-connecting switching device provided on a cathode line of the power line at a position between the first inverter and the second inverter.

The line-connecting switching device is a semiconductor switching device having larger parasitic capacitance than a switching device of the first inverter and a switching device of the second inverter.

The power converter of the present disclosure includes: the first inverter connected to the power line and each phase of the open-end winding motor; the second inverter connected to the power line and each phase of the open-end winding motor; and the line-connecting switching device provided on the cathode line of the power line at a position between the first inverter and the second inverter. The power line is connected to the energy storage device. The line-connecting switching device is a semiconductor switching device having larger parasitic capacitance than the switching device of the first inverter and the switching device of the second inverter. A surge voltage of a switching surge in the line-connecting switching device increases as a breaking current increases, and decreases as the parasitic capacitance of the line-connecting switching device increases. Therefore, the use of a semiconductor switching device having large parasitic capacitance as the line-connecting switching device can reduce the surge voltage of the switching surge in the line-connecting switching device.

In the power converter of the present disclosure, the line-connecting switching device may be a silicon insulated-gate bipolar transistor (Si-IGBT) or a silicon metal-oxide-semiconductor field-effect transistor (Si-MOSFET), and Each of the switching device of the first inverter and the switching device of the second inverter may be a silicon carbide metal-oxide-semiconductor field-effect transistor (SiC-MOSFET).

The power converter of the present disclosure may further include a controller configured to control on and off of the line-connecting switching device.

The controller may be configured to, when the controller turns the line-connecting switching device from on to on, turn off the line-connecting switching device when the value of any one of three-phase currents of the open-end winding motor becomes zero. As described above, a surge voltage of a switching surge in the line-connecting switching device increases as a breaking current increases. Therefore, it is preferable to turn off the line-connecting switching device when a current flowing through the line-connecting switching device becomes small. The current flowing through the line-connecting switching device is the sum of the three-phase currents of the open-end winding motor. The sum of the three-phase currents of the open-end winding motor becomes small when the value of any one of the three-phase currents of the open-end winding motor becomes zero. Therefore, a surge voltage of a switching surge can be reduced by turning off the line-connecting switching device when the value of any one of the three-phase currents of the open-end winding motor becomes zero.

The power converter of the present disclosure may further include a capacitor connected in parallel with the line-connecting switching device. As described above, a surge voltage of a switching surge in the line-connecting switching device increases as the parasitic capacitance of the line-connecting switching device increases. Therefore, when the power converter includes the capacitor connected in parallel with the line-connecting switching device, the capacitance of the capacitor is added to the parasitic capacitance of the line-connecting switching device. As a result, a surge voltage of a switching surge in the line-connecting switching device is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of the configuration of a drive device 20 including a power converter 30 according to an embodiment of the present disclosure;

FIG. 2 illustrates an example of changes with time of the parasitic capacitance and drain-source (DS) voltage of the connecting switch 36 when the connecting switch 36 is turned from on to off;

FIG. 3 illustrates an example of changes with time of the three-phase currents of the open-end winding motor 40 and a current flowing through the connecting switch 36;

FIG. 4 is a flowchart of an example of a switch-off process that is performed by the electronic control unit 38; and

FIG. 5 is a configuration diagram schematically showing the configuration of a drive device 20B including a power converter 30B according to a modification.

### DETAILED DESCRIPTION OF EMBODIMENTS

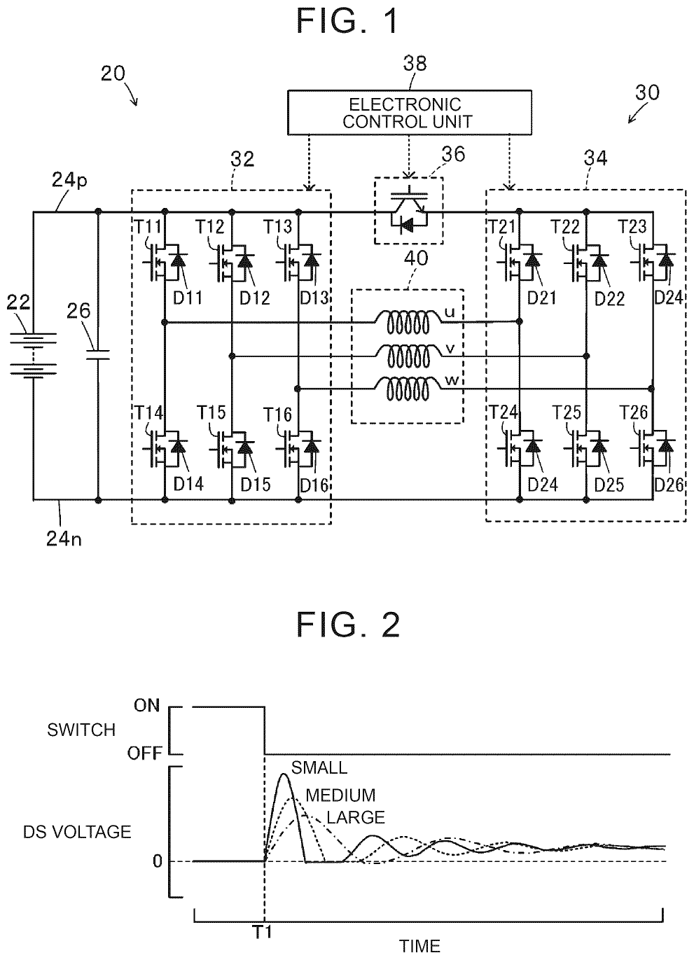

Next, a mode for carrying out the present disclosure (embodiment) will be described. FIG. 1 is a configuration diagram schematically showing the configuration of a drive device 20 including a power converter 30 according to an embodiment of the present disclosure. The drive device 20 includes a battery 22, a power converter 30, and an open-end winding motor 40.

The battery 22 is configured as, for example, a lithium-ion secondary battery or a nickel-metal hydride secondary battery, and the cathode terminal and the anode terminal are connected to the cathode power line 24p and the anode power line 24n. A smoothing capacitor 26 is attached to the cathode power line 24p and the anode power line 24n.

The power converter 30 includes a first inverter 32, a second inverter 34, a connecting switch 36, and an electronic control unit 38.

The first inverter 32 is connected to the cathode power line 24p and the anode power line 24n to which the battery 22 is connected. The first inverter 32 includes six transistors T11 to T16 as switching devices, and six diodes D11 to D16 respectively connected in parallel with the six transistors T11 to T16. Each of the transistors T11 to T16 is an SiC-MOSFET (SiC-Metal-Oxide Semiconductor Field-Effect Transistor). The pairs of transistors T11 to T16 are disposed so as to be a source and a sink with respect to the cathode power line 24p and the anode power line 24n. The pairs of transistors T11 to T16 are the transistors T11, T14, the transistors T12, T15, and the transistors T13, T16. Each of the connection points of the pairs of transistors T11 to T16 is connected to one end of a corresponding one of the three-phase coils (u-phase, v-phase, and w-phase coils) of the open-end winding motor 40.

The second inverter 34 is connected to the cathode power line 24p and the anode power line 24n, to which the battery 22 is connected, such that the first inverter 32 is sandwiched between the second inverter 34 and the battery 22. The second inverter 34 includes six transistors T21 to T26 as switching devices, and six diodes D21 to D26 respectively connected in parallel with the six transistors T21 to T26. Each of the transistors T21 to T26 is an SiC-MOSFETs (SiC-Metal-Oxide Semiconductor Field-Effect Transistor). The pairs of transistors T21 to T26 are disposed so as to be a source and a sink with respect to the cathode power line 24p and the anode power line 24n. The pairs of transistors T21 to T26 are, for example, the transistors T21, T24, the transistors T22, T25, the transistors T23, T26. Each of the connection points of the pairs of transistors T21 to T26 is connected to the other end of a corresponding one of the three-phase coils (u-phase, v-phase, and w-phase coils) of the open-end winding motor 40.

The connecting switch 36 is provided on the cathode power line 24p at a position between the first inverter 32 and the second inverter 34. The connecting switch 36 is an Si-IGBT (Si-Insulated Gate Bipolar Transistor) having larger parasitic capacitance than the transistors T11 to T16 of the first inverter 32 and the transistors T21 to T26 of the second inverter 34.

The electronic control unit 38 is configured as a microcomputer including a CPU as a core. The electronic control unit 38 also serves as a controller for the drive device 20, and calculates a torque command for the open-end winding motor 40 based on a drive command, not shown. The electronic control unit 38 also controls switching of the six transistors T11 to T16 of the first inverter 32 and the six transistors T21 to T26 of the second inverter 34, and controls on and off of the connecting switch 36.

The open-end winding motor 40 is a generator motor in which both ends of the three-phase windings, i.e., the u-phase, v-phase, and w-phase windings, are configured as connection terminals. Each of the three connection points of the pairs of transistors of the first inverter 32 is connected to one end of a corresponding one of the three-phases windings, namely the u-phase, v-phase, and w-phase windings. Each of the three connection points of the pairs of transistors of the second inverter 34 is connected to the other end of a corresponding one of the three-phase windings, namely the u-phase, v-phase, and w-phase windings.

In the power converter 30 of the embodiment, the connecting switch 36 is turned off, the transistors T21 to T23 of the upper arm of the second inverter 34 are turned on, and the transistors T24 to T26 of the lower arm are turned off. In this condition, the open-end winding motor 40 can be driven in Y-connection by controlling switching of the transistors T11 to T16 of the first inverter 32. That is, the connecting switch 36 is turned off, and the transistors T21 to T23 of the upper arm of the second inverter 34 are turned on. As a result, a neutral point is set by the transistors T21 to T23 in which the u-phase, v-phase, and w-phase of the open-end winding motor 40 are turned on, and the open-end winding motor 40 is driven by the first inverter 32 as a Y-connection motor. In the power converter 30 of the embodiment, with the connecting switch 36 turned on, switching of the transistors T11 to T16 of the first inverter 32 is controlled and switching of the transistors T21 to T26 of the second inverter 34 is controlled. The open-end winding motor 40 can thus be driven in Δ-connection.

In the power converter 30 of the embodiment, the connecting switch 36 is a device (Si-IGBT) having larger parasitic capacitance than the transistors T11 to T16 of the first inverter 32 and the transistors T21 to T26 of the second inverter 34. This reduces a surge voltage of a switching surge that occurs when the drive mode is switched from the Δ-connection drive mode in which the connecting switch 36 is turned on to the Y-connection drive mode in which the connecting switch 36 is turned off. FIG. 2 shows an example of changes with time of the parasitic capacitance and drain-source (DS) voltage of the connecting switch 36 when the connecting switch 36 is turned from on to off. Regarding the DS voltage in the figure, a continuous line represents the DS voltage when a device having small parasitic capacitance is used as the connecting switch 36. A dashed line represents the DS voltage when a device having medium parasitic capacitance is used as the connecting switch 36. A long dashed short dashed line represents the DS voltage when a device having large parasitic capacitance is used as the connecting switch 36. As illustrated, the larger the parasitic capacitance of the connecting switch 36 is, the lower the surge voltage of the switching surge can be. Therefore, in the power converter 30 of the embodiment, a device (Si-IGBT) having large parasitic capacitance is used as the connecting switch 36.

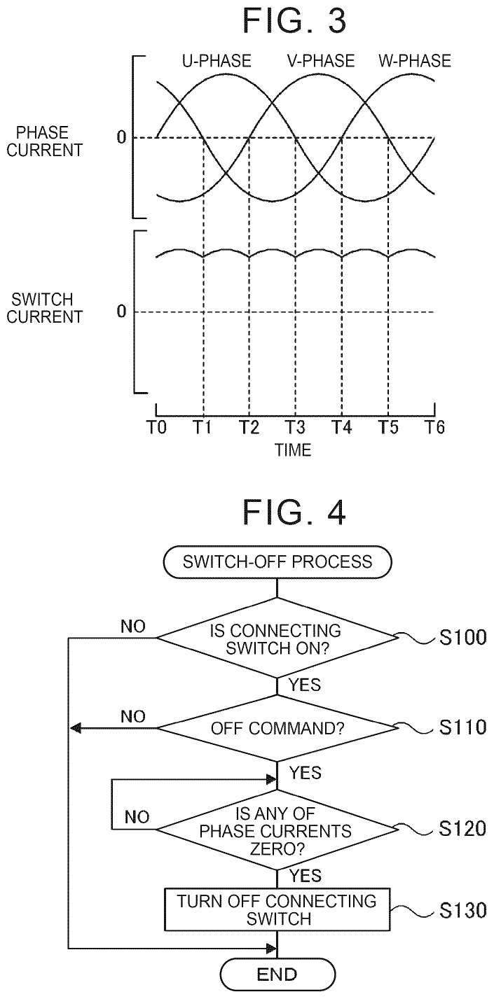

A surge voltage of a switching surge in the connecting switch 36 decreases as the cutoff current decreases. Therefore, in the power converter 30 of the embodiment, the current flowing through the connecting switch 36 is turned off at a timing of decreasing. The current flowing through the connecting switch 36 is the sum of the three-phase (u-phase, v-phase, w-phase) currents of the open-end winding motor 40. The sum of the three-phase currents of the open-end winding motor 40 decreases when the value of any one of the three-phase currents of the open-end winding motor 40 becomes zero. Therefore, the connecting switch 36 is turned off when the value of any one of the three-phase currents of the open-end winding motor 40 becomes zero. FIG. 3 shows an example of changes with time of the three-phase currents of the open-end winding motor 40 and the current flowing through the connecting switch 36. As illustrated, the current flowing through the connecting switch 36 is minimized when the value of any one of the three-phase currents of the open-end winding motor 40 becomes zero. That is, in FIG. 3, the connecting switch 36 may be turned off at any time during the period from time T0 to time T6. FIG. 4 is a flowchart of an example of a switch-off process that is performed by the electronic control unit 38 when the connecting switch 36 is turned off.

When the switch-off process is performed, the electronic control unit 38 first determines whether the connecting switch 36 is on (S100). When it is determined that the connecting switch 36 is not on (that is, off), it is determined that the present processing is not to be performed, and this process ends. On the other hand, when it is determined that the connecting switch 36 is on, it is determined whether there is a command to turn off the connecting switch 36 (S110). When it is determined that there is no command to turn off the connecting switch 36, it is determined that this process is not to be performed, and this process ends. On the other hand, when it is determined that there is a command to turn off the connecting switch 36, the connecting switch 36 is turned off (S130) when the value of any one of the three-phase currents of the open-end winding motor 40 becomes zero (S120), and this process ends.

In the power converter 30 of the above embodiment, the connecting switch 36 is a device (Si-IGBT) having larger parasitic capacitance than the transistors T11 to T16 of the first inverter 32 and the transistors T21 to T26 of the second inverter 34. This can reduce a surge voltage of a switching surge that occurs when the drive mode is switched from the Δ-connection drive mode in which the connecting switch 36 is turned on to the Y-connection drive mode in which the connecting switch 36 is turned off.

In the power converter 30 of the embodiment, the connecting switch 36 is turned off when the value of any one of the three-phase currents of the open-end winding motor 40 becomes zero. This reduces a surge voltage of a switching surge that occurs when the connecting switch 36 is turned from on to off.

In the power converter 30 of the embodiment, the connecting switch 36 is an Si-IGBT. However, the connecting switch 36 may be an Si-MOSFET because it may be any device having larger parasitic capacitance than the transistors T11 to T16 of the first inverter 32 and the transistors T21 to T26 of the second inverter 34.

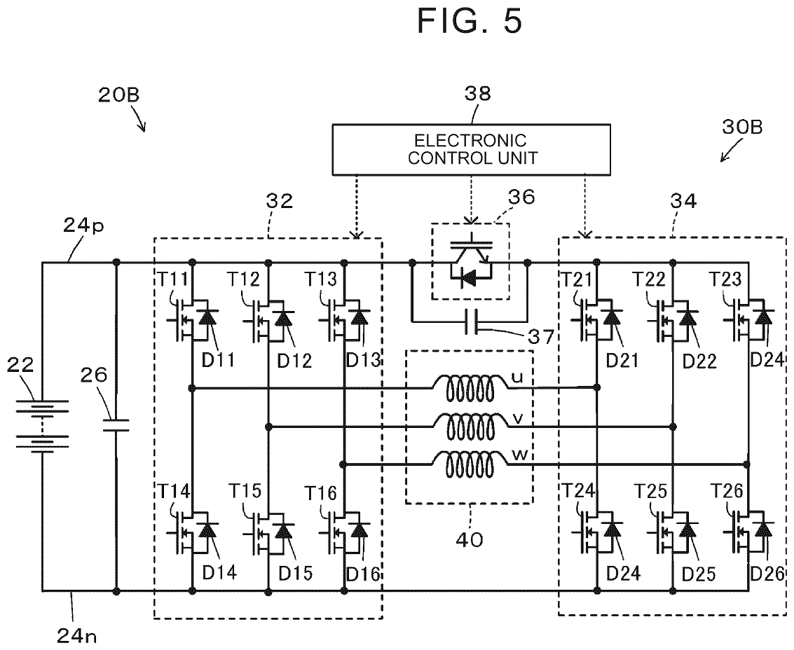

In the power converter 30 of the embodiment, the connecting switch 36 is an Si-IGBT having large parasitic capacitance. However, since the power converter may have any configuration as long as the connecting switch 36 has large substantial parasitic capacitance, the power converter may include a capacitor 37 connected in parallel with the connecting switch 36, as shown in a power converter 30B of a drive device 20B of a modification in FIG. 5. In this case, although the number of devices in the power converter increases, it is possible to drastically reduce a surge voltage of a switching surge that occurs when the connecting switch 36 is turned from on to off.

The correspondence between the main elements of the embodiments and the main elements of the disclosure described in the column of the means for solving the problem will be described. In the embodiment, the battery 22 corresponds to the “energy storage device,” and the open-end winding motor 40 corresponds to the “open-end winding motor.” In the embodiment, the first inverter 32 corresponds to the “first inverter,” the second inverter 34 corresponds to the “second inverter,” and the connecting switch 36 corresponds to the “line-connecting switching device.” The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to the manufacturing industry of power converters etc.

What is claimed is:

1. A power converter connected to an energy storage device and a three-phase open-end winding motor, the power converter comprising:
a first inverter connected to a power line and each of three phases of the open-end winding motor, the power line being connected to the energy storage device;
a second inverter connected to the power line and each of the three phases of the open-end winding motor; and
a line-connecting switching device provided on a cathode line of the power line at a position between the first inverter and the second inverter,
wherein the line-connecting switching device is a semiconductor switching device having larger parasitic capacitance than a switching device of the first inverter and a switching device of the second inverter.

2. The power converter according to claim 1, wherein:
the line-connecting switching device is a silicon insulated-gate bipolar transistor or a silicon metal-oxide-semiconductor field-effect transistor; and
each of the switching device of the first inverter and the switching device of the second inverter is a silicon carbide metal-oxide-semiconductor field-effect transistor.

3. The power converter according to claim 1, further comprising
a controller configured to control on and off of the line-connecting switching device,
wherein the controller is configured to, when the controller turns the line-connecting switching device from on to on, turn off the line-connecting switching device when a value of any one of three-phase currents of the open-end winding motor becomes zero.

4. The power converter according to claim 1, further comprising
a capacitor connected in parallel with the line-connecting switching device.
